(19) United States
(12) Patent Application Publication
(10) Pub. No.: US 2025/0149824 A1
(43) Pub. Date: May 8, 2025

(54) CONNECTOR

(71) Applicant: YAZAKI CORPORATION, Tokyo (JP)

(72) Inventors: Sota Kawarasaki, Makinohara-shi (JP); Masaaki Iwabe, Makinohara-shi (JP); Masaki Ota, Makinohara-shi (JP); Satoshi Nakahara, Makinohara-shi (JP); Noriyuki Maki, Makinohara-shi (JP)

(21) Appl. No.: 18/911,170

(22) Filed: Oct. 9, 2024

(30) Foreign Application Priority Data
Nov. 8, 2023 (JP) 2023-190863

(51) Int. Cl. H01R 13/52

(52) U.S. Cl. CPC H01R 13/5202; H01R 13/5213

(57) ABSTRACT

There is provided a connector including: a housing having a fitting portion to be fitted to a counterpart connector; a cover assembled to an opening opposite to the fitting portion; an annular seal member sealing a gap between the opening and the cover; a plurality of reinforcing ribs disposed at predetermined intervals along an inner peripheral surface of the housing and extending along an assembling direction of the cover, the inner peripheral surface of the housing being located behind the inner peripheral side seal surface of the opening; engaging projections projecting from an inner bottom surface of the cover and configured to restrict displacement of the cover with respect to the housing by being meshed with the reinforcing ribs; a component fixed to the cover; and a fixing bolt screwed into a nut provided on the cover for fixing the component.

### CROSS-REFERENCE TO RELATED APPLICATIONS

This application is based on and claims priority under 35 USC 119 from Japanese Patent Application No. 2023-190863 filed on Nov. 8, 2023, the contents of which are incorporated herein by reference.

### TECHNICAL FIELD

The present disclosure relates to a connector.

### BACKGROUND ART

In the related art, as disclosed in, for example, JP2014-086150A, JP2015-082466A, and JP2022-002194A, a connector attached to a case of a device includes a housing made of synthetic resin and formed in a substantially L shape. The housing includes a fitting portion that accommodates a terminal connected to an end of an electric wire and is fitted to a device-side connector (counterpart connector), and an electric wire introduction portion into which the electric wire connected to the terminal is introduced from a direction intersecting a fitting direction of the fitting portion. The housing has a working hole (opening) on an opposite side to the fitting portion, and a cover is attached to the working hole.

A seal ring (annular seal member) in close contact with an inner peripheral surface (inner peripheral side seal surface) of the working hole to seal the inside of the housing is assembled to an outer peripheral side seal surface of the cover. The cover is attached to the working hole so as not to allow water or the like to enter the housing from the working hole. That is, the seal ring seals a gap between the inner peripheral side seal surface of the working hole and the outer peripheral side seal surface of the cover.

In addition, there is known a connector in which an inspection probe for an electrical inspection is inserted into an inspection hole provided in a back side of the connector, and a confirmation operation as to whether electricity flows through a terminal accommodated in a housing can be performed. In the case of such a connector, the inspection hole may be provided in the cover, and when the connector is mounted in a non-waterproof space, it is necessary to block water from entering the inspection hole with a blocking plug. Therefore, it is necessary to fix an inspection plate (component) for holding a blocking plug that blocks water from entering the inspection hole in the cover. Such an inspection plate is generally bolted to the cover by a fixing bolt screwed into a nut provided on the cover.

The cover attached to the working hole is centered and positioned relative to the inner peripheral side seal surface of the working hole by a reaction force of the annular seal member. When a force other than the reaction force of the seal member is applied to the cover attached to the working hole, the cover may be biased.

Therefore, when the above-described inspection plate is bolted to the cover, a fastening torque of the fixing bolt is applied to the cover and co-rotates, so that the cover may be biased and a sealing margin of the seal member may not be secured.

### SUMMARY OF INVENTION

The present disclosure provides a connector capable of preventing a reduction in sealing performance caused by the occurrence of a bias of a cover when a component is bolted to the cover.

According to an illustrative aspect of the present disclosure, a connector includes: a housing having a fitting portion configured to be fitted to a counterpart connector; a cover assembled to an opening opposite to the fitting portion; an annular seal member configured to seal a gap between an inner peripheral side seal surface of the opening and an outer peripheral side seal surface of the cover; a plurality of reinforcing ribs disposed at predetermined intervals along an inner peripheral surface of the housing and extending along an assembling direction of the cover, the inner peripheral surface of the housing being located behind the inner peripheral side seal surface of the opening; engaging projections projecting from an inner bottom surface of the cover and configured to restrict displacement of the cover with respect to the housing by being meshed with the reinforcing ribs; a component fixed to the cover; and a fixing bolt screwed into a nut provided on the cover for fixing the component.

According to the connector of the present disclosure, it is possible to prevent a reduction in sealing performance caused by the occurrence of a bias of a cover when a component is bolted to the cover.

The present disclosure has been briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a connector according to an embodiment of the present disclosure;

FIG. 2 is an exploded perspective view of the connector in FIG. 1;

FIG. 3 is a perspective view illustrating an assembling procedure of the connector illustrated in FIG. 2;

FIG. 4 is a rear view of a housing illustrated in FIG. 2;

FIG. 5 is a perspective view of an inner bottom surface side of a cover illustrated in FIG. 2;

FIG. 6 is a front view illustrating an inner bottom surface of the cover to which a seal member is attached;

FIG. 7 is a perspective view illustrating the assembling procedure of the connector illustrated in FIG. 2;

FIG. 8 is a schematic left side view of the connector illustrated in FIG. 1;

FIG. 9 is a cross-sectional view taken along a line IX-IX in FIG. 8;

FIG. 10 is an enlarged view of main parts in FIG. 11; and

FIG. 11 is a rear view of the connector illustrated in FIG. 1.

### DESCRIPTION OF EMBODIMENTS

Hereinafter, examples of embodiments according to the present disclosure will be described with reference to the drawings.

### Embodiment

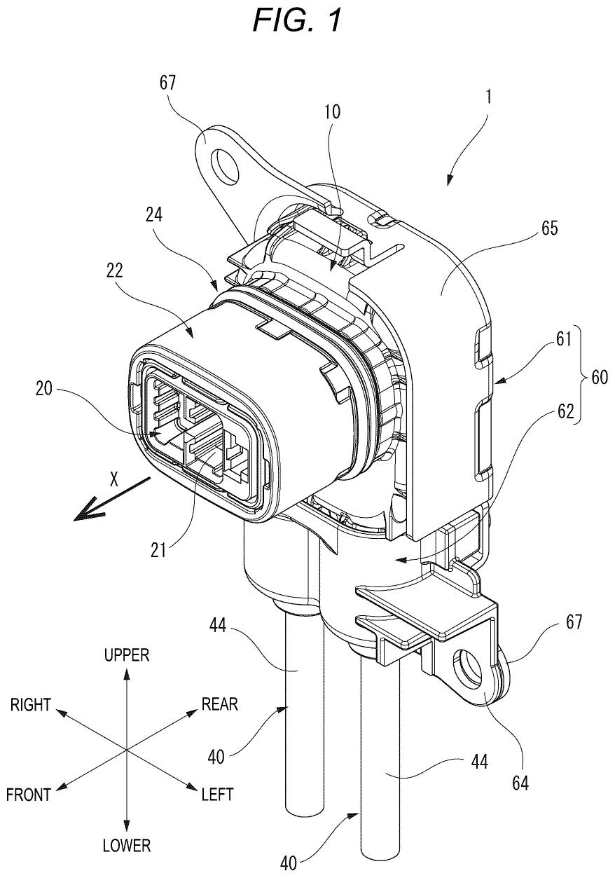

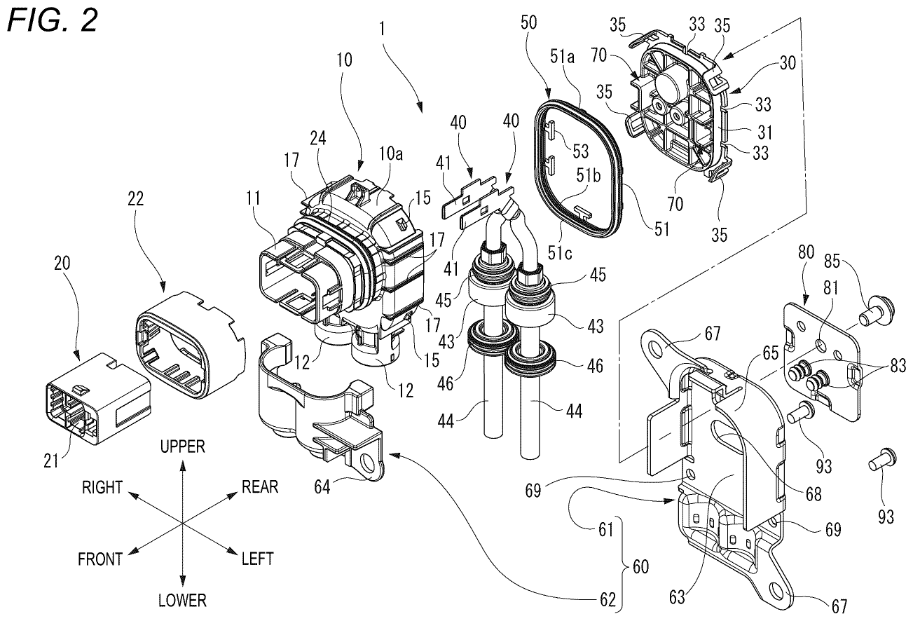

FIGS. 1 and 2 are a perspective view and an exploded perspective view of a connector 1 according to an embodiment of the present disclosure.

In the present specification, a front-rear direction, an up-down direction, and a left-right direction of the connector 1 follow directions of arrows in FIGS. 1 to 3. That is, the front-rear direction is a direction along a connector fitting direction of the connector 1, and a side to which a not-illustrated counterpart connector is fitted is referred to as a front side of a housing 10. The up-down direction is an extension direction of a shielded electric wire 44 orthogonal to the connector fitting direction of the connector 1, and a derivation direction of the shielded electric wire 44 is a downward direction. Further, the left-right direction is a longitudinal direction of a rectangular opening in a bottomed cylindrical fitting portion 11 orthogonal to the connector fitting direction.

As illustrated in FIGS. 1 and 2, the connector 1 according to the present embodiment includes the housing 10, two terminal-equipped electric wires 40, a cover 30, a seal member 50, a shield shell 60, and an inspection plate 80. The connector 1 is, for example, a shielded connector used in a power supply circuit such as an inverter or a motor of a vehicle such as a hybrid vehicle or an electric vehicle. The connector 1 is fitted and electrically connected to a counterpart connector provided in a case such as an inverter or a motor.

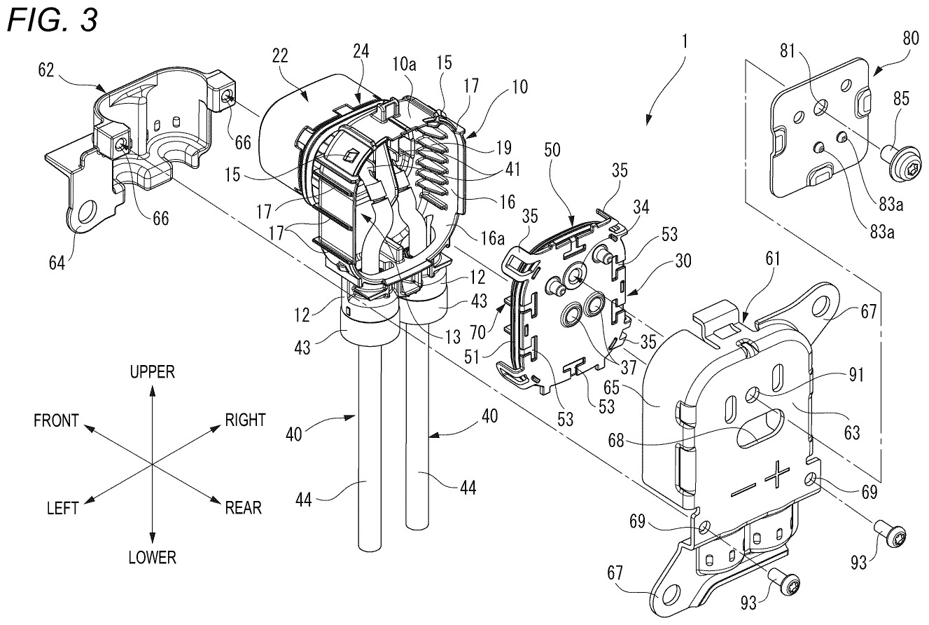

As illustrated in FIGS. 2 and 3, the housing 10 is a housing formed in a substantially L shape, and includes a fitting portion 11 that accommodates tab terminals (terminals) 41 of the terminal-equipped electric wires 40 and is fitted to a device-side connector (counterpart connector), and electric wire introduction portions 12 that are introduced from a direction in which terminals of the shielded electric wires 44 connected to the tab terminals 41 intersect with a fitting direction X (see FIG. 1) of the fitting portion 11.

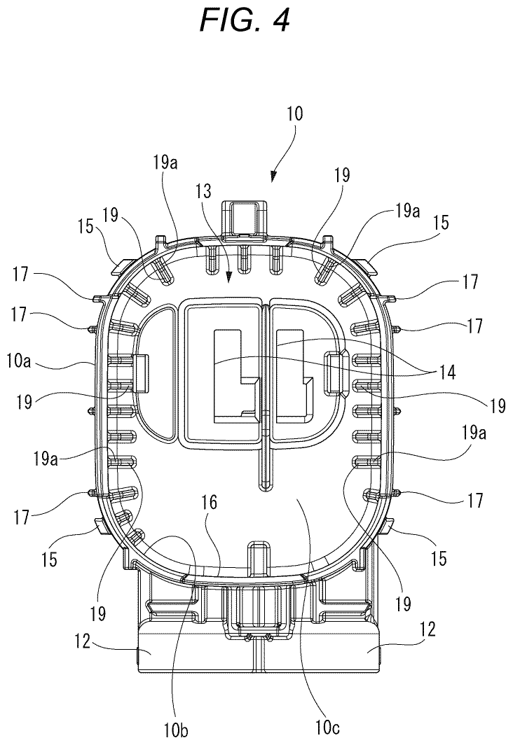

The fitting portion 11 is formed in a bottomed cylindrical shape having a rectangular opening, and protrudes forward in the fitting direction X of the housing 10 with the counterpart connector. A pair of terminal through holes (see FIG. 4) is formed in a bottom portion of the fitting portion 11.

A packing 24 and a front holder 22 are assembled to an outer periphery of the fitting portion 11, and an inner housing 20 including a terminal accommodating chamber 21 is assembled to an inner periphery of the fitting portion 11.

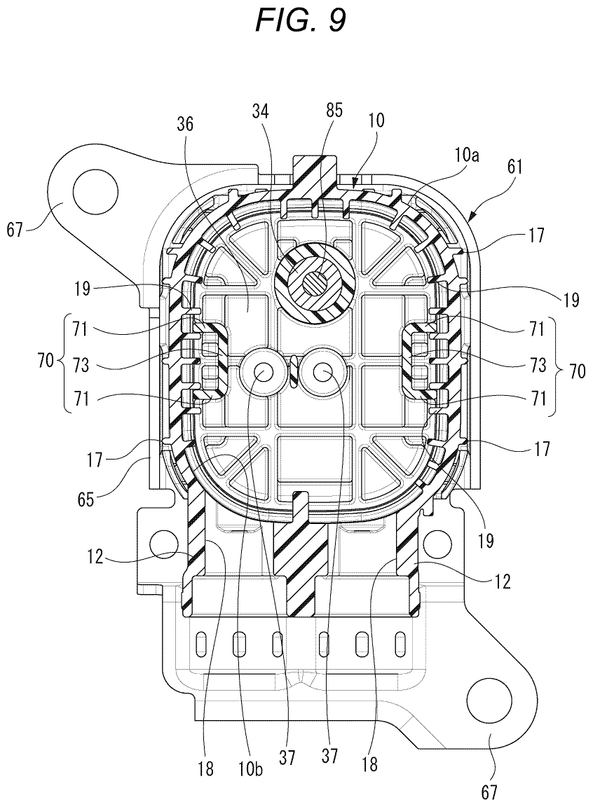

Each electric wire introduction portion 12 extends in a downward direction that intersects with the fitting direction X of the housing 10 with the counterpart connector. Electric wire through holes 18 (see FIG. 9) through which the shielded electric wires 44 are inserted are formed in the electric wire introduction portions 12.

A rear portion of the housing 10 opposite to the fitting portion 11 is an accommodating portion 13 formed in a concave shape open to an opening 16. The cover 30 is assembled to the opening 16 opposite to the fitting portion 11 in the rear portion of the housing 10. The housing 10 and the cover 30 are formed of synthetic resin having electrical insulation properties. When the cover 30 is assembled to the housing 10, the opening 16, which is an attaching working hole of the terminal-equipped electric wire 40, is covered with the cover 30.

As illustrated in FIGS. 3 and 4, a plurality of ribs 17 are disposed along an outer peripheral surface 10a of the housing 10 corresponding to the outside of the opening 16. Each rib 17 is a protrusion having a rectangular cross-section extending along an assembling direction of an upper shield shell 61 to be described later. In addition, a plurality of locking claws 15 project from the outer peripheral surface 10a of the housing 10.

As illustrated in FIGS. 3 and 4, a plurality of reinforcing ribs 19 are disposed at an inside corner of the accommodating portion 13 to prevent deformation of the accommodating portion 13. The reinforcing ribs 19 are disposed at predetermined intervals along an inner peripheral surface 10b of the housing 10 located behind an inner peripheral side seal surface 16a of the opening 16, and extend along an assembling direction of the cover 30 (front-rear direction of the connector 1).

That is, each reinforcing rib 19 extends from a bottom surface 10c of the housing 10 toward an open end of the opening 16 along the inner peripheral surface 10b, and an end in an extension direction of the reinforcing rib 19 is located on the inner peripheral side seal surface 16a. The reinforcing rib 19 has a contact surface 19a on the end in the extension direction that is parallel to a width direction end surface 51c of a seal body portion 51 when the cover 30 is assembled to the opening 16.

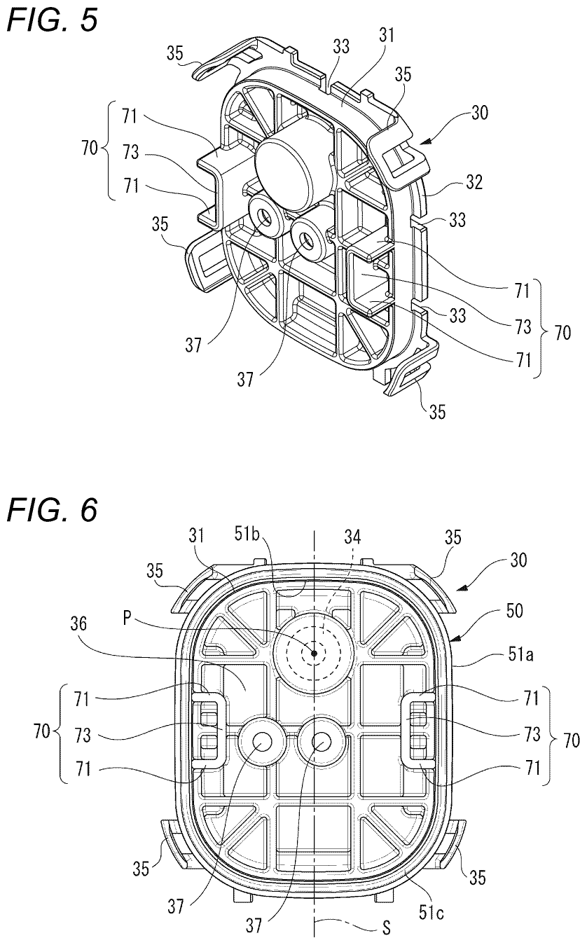

As illustrated in FIGS. 5 and 6, the cover 30 is formed in a substantially rectangular plate shape. The cover 30 is assembled to the opening 16 of the housing 10 from a rear side via the annular seal member 50.

The cover 30 includes an outer peripheral side seal surface 31 having an outer peripheral shape corresponding to the opening 16 of the housing 10 and onto which the seal member 50 is fitted, and a flange portion 32 projecting from a rear end of the outer peripheral side seal surface 31 in an assembling direction toward an outer diameter direction. The flange portion 32 restricts rearward movement of the seal member 50 fitted onto the outer peripheral side seal surface 31.

A pair of inspection holes 37 for inserting inspection probes for an electrical inspection (not illustrated) are formed through the cover 30. As illustrated in FIG. 3, on a back side of the cover 30, a cap nut (nut) 34 for bolting the inspection plate 80 to be described later to a back side of the connector 1 is integrally molded by insert molding.

Further, a pair of engaging projections 70 project from an inner bottom surface 36 of the cover 30 to restrict displacement of the cover 30 with respect to the housing 10 by being meshed with the reinforcing ribs 19 of the housing 10.

As illustrated in FIG. 6, the pair of engaging projections 70 are disposed plane-symmetrically with respect to a central plane S of the cover 30 including an axis P of the cap nut 34 disposed on a center of the cover 30 in the up-down direction.

When the cover 30 rotates about an axis P of the cap nut 34, the same rotational moment acts on the pair of engaging projections 70. Accordingly, since shapes of the pair of engaging projections 70 on which rotational torque of the cover 30 acts equally can be the same shape in strength, the resin molding of the cover 30 is facilitated.

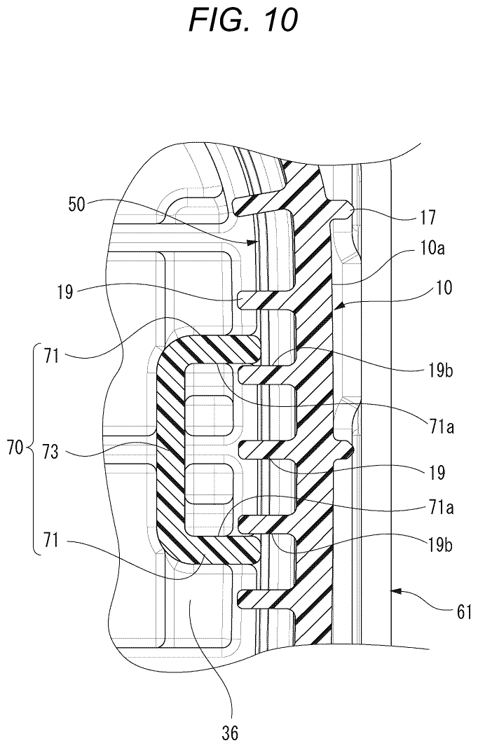

Each engaging projection 70 is a columnar projection having a U-shaped cross-section in which a pair of support pieces 71 having inner surfaces 71a facing outer surfaces 19b of a pair of reinforcing ribs 19 in a plate thickness direction and a connection piece 73 connecting the pair of support pieces 71 are integrally formed (see FIG. 10).

When the cover 30 rotates about the axis P of the cap nut 34, the inner surfaces 71a of the support pieces 71 of the engaging projections 70 can apply rotational torque to the reinforcing ribs 19 while being in surface contact with the outer surfaces 19b. Accordingly, since the stress acting between the engaging projections 70 and the reinforcing ribs 19 can be dispersed, damage to the engaging projections 70 and the reinforcing ribs 19 can be prevented without increasing a size and strength more than necessary.

As illustrated in FIG. 2, the seal member 50 includes the seal body portion 51 formed in an annular shape by an elastic material such as rubber, and a plurality of T-shaped locking pieces 53 projecting toward a center from a rear end side of the seal body portion 51 in a fitting direction. Each of the T-shaped locking pieces 53 is formed in a T-shape in which a distal end portion thereof extends in the left-right direction.

An outer lip 51a is provided on an outer peripheral surface of the seal body portion 51 to be in close contact with the inner peripheral side seal surface 16a of the opening 16. An inner lip 51b is provided on an inner peripheral surface of the seal body portion 51 to be in close contact with the outer peripheral side seal surface 31 of the cover 30. Further, the width direction end surface 51c of the seal body portion 51 can face the contact surface 19a formed in the end in the extension direction of the reinforcing rib 19.

The seal member 50 is attached to the outer peripheral side seal surface 31 of the cover 30, and waterproofs and seals a gap between the opening 16 of the housing 10 and the cover 30. In the seal member 50, the T-shaped locking pieces 53 are locked to locking portion recesses 33 formed on an outer peripheral edge of the cover 30, thereby preventing the seal member 50 from falling forward inadvertently.

The cover 30 attached to the opening 16 of the housing 10 is centered and positioned relative to the inner peripheral side seal surface 16a of the opening 16 by a reaction force of the annular seal member 50.

Accordingly, the opening 16 of the accommodating portion 13 of the housing 10 is sealed by the cover 30 in a watertight manner. A plurality of locking pieces 35 having locking holes are formed in a peripheral edge of the cover 30. The locking claws 15 formed in the housing 10 enter the locking holes of the locking pieces 35 by assembling the cover 30 to the housing 10. The locking pieces 35 are locked by the locking claws 15, and the cover 30 is held in an assembled state with respect to the housing 10.

As illustrated in FIG. 2, each terminal-equipped electric wire 40 includes the shielded electric wire 44, the tab terminal (terminal) 41 connected to a conductor terminal of the shielded electric wire 44, a shield terminal 43 connected to a braid of the shielded electric wire 44, and rubber plugs 45 and 46 for sealing a gap between the electric wire introduction portion 12 of the housing 10 and the shielded electric wire 44.

The shielded electric wire (electric wire) 44 is configured as a coaxial cable including a core wire disposed from a center thereof, an inner coating covering the core wire, a conductive braid covering the inner coating, and an outer sheath covering the braid.

The tab terminal 41 is formed of, for example, a conductive metal material such as copper, a copper alloy, aluminum, or an aluminum alloy. The tab terminal 41 is crimped to the core wire exposed at a terminal of the shielded electric wire 44 and is electrically connected to the shielded electric wire 44.

The tab terminal 41 is inserted into and electrically connected to an electrical connection portion of a counterpart terminal (not illustrated) provided in the counterpart connector.

In the terminal-equipped electric wire 40 assembled to the housing 10, the shielded electric wires 44 are inserted into the electric wire through holes 18 of the electric wire introduction portions 12, and the tab terminals 41 are inserted into terminal through holes 14 of the fitting portion 11 and are accommodated in the terminal accommodating chamber 21 of the inner housing 20. Thus, the tab terminals 41 of the terminal-equipped electric wires 40 are fixed to the fitting portion 11 of the housing 10.

The rubber plugs 45 and 46 are attached to the shielded electric wires 44 of the terminal-equipped electric wire 40. The rubber plug 45 seals a gap between the shield terminal 43 connected to the braid of the shielded electric wire 44 and the electric wire introduction portion 12. The rubber plug 46 seals a gap between the shielded electric wire 44 and the shield terminal 43. The rubber plugs 45 and 46 seal a gap between the shielded electric wire 44 and the electric wire introduction portion 12.

As illustrated in FIGS. 2 and 3, the connector 1 according to the present embodiment includes the shield shell 60 including an upper shield shell 61 assembled from a rear side of the housing 10 and a lower shield shell 62 assembled from a lower side. The upper shield shell 61 and the lower shield shell 62 are each made of a conductive metal material.

The upper shield shell (shield shell) 61 is formed in a box shape having a substantially rectangular flat bottom plate portion 63 and a peripheral wall 65 suspended from a peripheral edge of the bottom plate portion 63. The bottom plate portion 63 covers a rear surface of the housing 10, and the peripheral wall 65 covers an upper surface and left and right side surfaces (side surfaces) of the housing 10.

In addition, the upper shield shell 61 is provided with fixing pieces 67 in which hole portions are formed, and through holes 68, 69, and 91 that are formed to penetrate the bottom plate portion 63. The through hole 68 is a long circular opening for inserting inspection probes into the inspection holes 37 of the cover 30 from a back side of the upper shield shell 61. The through holes 69 are screw insertion holes through which attachment screws 93 for coupling the upper shield shell 61 and the lower shield shell 62 are inserted. The through hole 91 is a bolt insertion hole through which a fixing bolt 85 for bolting the inspection plate 80 to the cap nut 34 of the cover 30 is inserted.

The lower shield shell (shield shell) 62 covers a portion on a front surface of the housing 10 excluding the fitting portion 11. The lower shield shell 62 is provided with screw holes 66 and fixing pieces 64 in which hole portions are formed.

As illustrated in FIGS. 2 and 3, the inspection plate 80 is formed in a substantially rectangular plate shape and is formed of a conductive metal material.

The inspection plate 80 according to the present embodiment as a component fixed to the cover 30 holds blocking plugs 83 for blocking water from entering the inspection holes 37 of the cover 30 on an inner surface. The blocking plugs 83 are held by the inspection plate 80 by press-fitting press-fitting projections 83a from the front into a pair of attachment holes formed in the inspection plate 80.

A bolt insertion hole 81 through which the fixing bolt 85 is inserted is formed in the inspection plate 80. The inspection plate 80 is attached to the back side of the upper shield shell 61 to cover the through hole 68 through which the blocking plugs 83 are inserted.

Thus, the inspection plate 80 covers the long circular through hole 68 of the upper shield shell 61, through which inspection probes or the blocking plugs 83 are inserted, from the back side of the upper shield shell 61, thereby preventing a reduction in shielding performance.

The inspection plate 80 for holding the blocking plugs 83 is bolted to the cover 30 via the upper shield shell 61 by the fixing bolt 85 screwed to the cap nut 34.

Next, a case of assembling the connector 1 according to the present embodiment will be described.

First, as illustrated in FIG. 3, after the shielded electric wires 44 of the terminal-equipped electric wires 40 are passed through the electric wire introduction portions 12 of the housing 10 and the tab terminals 41 are pulled out toward the accommodating portion 13, the tab terminals 41 are inserted into the terminal through holes 14 of the housing 10.

The cover 30 is brought close to the accommodating portion 13 of the housing 10 to cover the opening 16 from a rear side, and the locking claws 15 of the housing 10 are locked to the locking pieces 35 of the cover 30.

Thus, in the seal member 50 attached such that the inner lip 51b is in close contact with the outer peripheral side seal surface 31 of the cover 30, the outer lip 51a is in close contact with the inner peripheral side seal surface 16a of the opening 16. Thus, the seal member 50 attached to the housing 10 can waterproof and seal a gap between the opening 16 of the housing 10 and the cover 30.

The engaging projections 70 of the cover 30 mesh with the reinforcing ribs 19 such that the inner surfaces 71a of the pair of support pieces 71 face the outer surfaces 19b of the pair of reinforcing ribs 19 in the plate thickness direction. Thus, the engaging projections 70 can restrict rotational displacement of the cover 30 with respect to the housing 10 around the axis P of the cap nut 34 (see FIGS. 9 and 10).

The engaging projection 70 also serves as a guide when the cover 30 is assembled to the opening 16 of the housing 10, and is assembled while the inner surfaces 71a slide with respect to the outer surfaces 19b of the reinforcing ribs 19. Accordingly, the engaging projections 70 can prevent excessive assembly such as the insertion of the cover 30 extremely inclined with respect to the opening 16, and can prevent an excessive load on the locking piece 35 during the meshing of the seal member 50 and assembly of the cover 30.

Next, the shield shell 60 is attached to the housing 10.

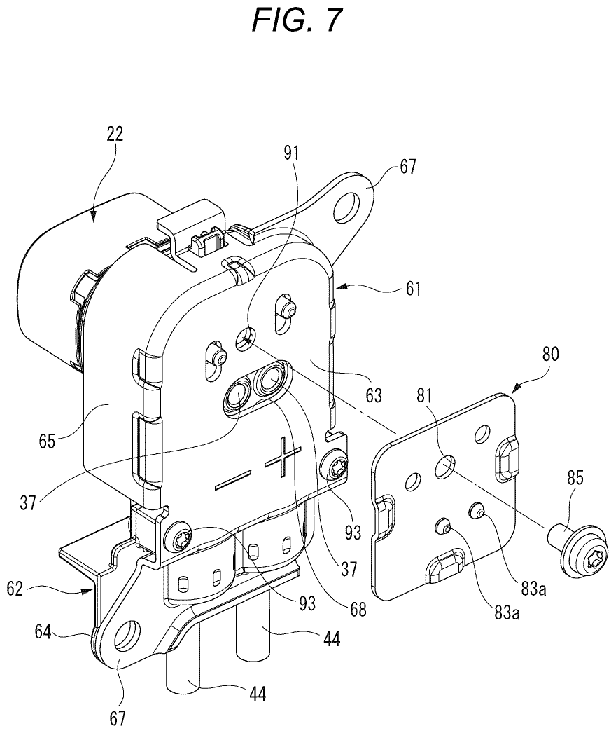

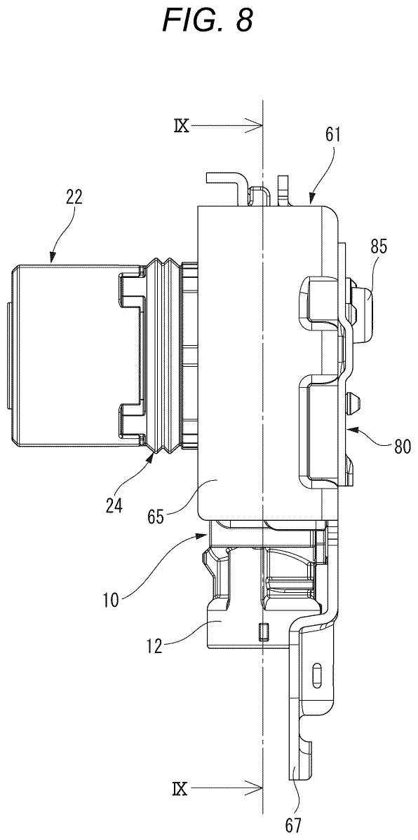

First, as illustrated in FIGS. 7 and 8, the upper shield shell 61 of the shield shell 60 is attached from the rear side to cover the housing 10 to which the cover 30 is assembled. At this time, an inner surface of the peripheral wall 65 of the housing 10 is guided into and guided by the plurality of ribs 17 projecting from the outer peripheral surface 10a of the housing 10.

Next, the lower shield shell 62 of the shield shell 60 is attached from the lower side to cover the electric wire introduction portion 12 of the housing 10.

The upper shield shell 61 and the lower shield shell 62 are attached to the housing 10, and the through holes 69 of the upper shield shell 61 and the screw holes 66 of the lower shield shell 62 communicate with each other. Thereafter, the upper shield shell 61 and the lower shield shell 62 are fixed to the housing 10 by inserting the attachment screws 93 into the through holes 69 and screwing the attachment screws 93 into the screw holes 66.

The upper shield shell 61 and the lower shield shell 62 are electrically connected to each other via the attachment screws 93. Further, one end of the braid of the shielded electric wires 44 is electrically connected to the shield shell 60 by the shield terminal 43 of the terminal-equipped electric wire 40.

The inspection plate 80 is attached to the back side of the upper shield shell 61 such that the blocking plugs 83 are inserted into the through hole 68 of the upper shield shell 61 and close the inspection holes 37 of the cover 30.

Thereafter, the fixing bolt 85 inserted into the bolt insertion hole 81 of the inspection plate 80 and the through hole 91 of the upper shield shell 61 is screwed into the cap nut 34 of the cover 30.

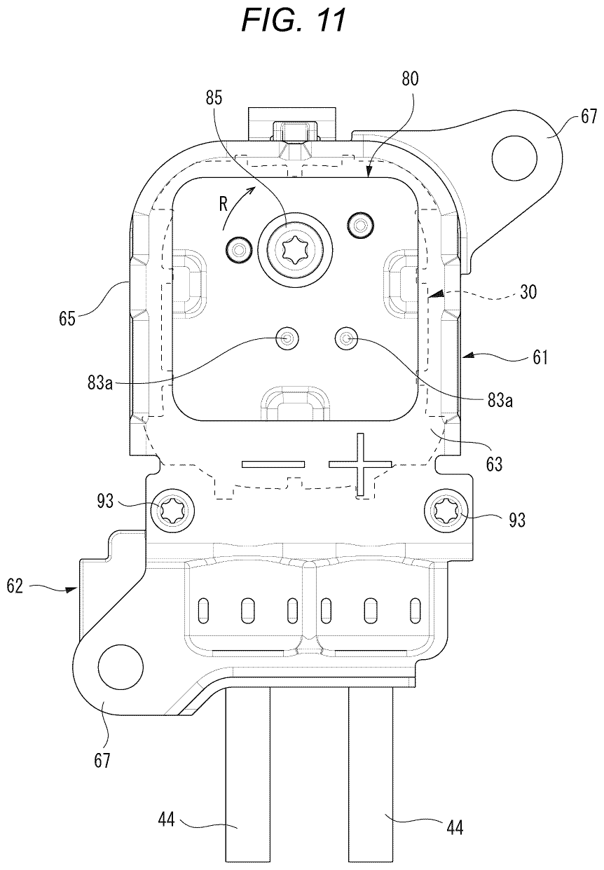

At this time, as illustrated in FIG. 11, it is possible that the cover 30 is co-rotated together with the fixing bolt 85 when a fastening torque of the fixing bolt 85 in a direction of an arrow R is applied to the cover 30. However, as illustrated in FIGS. 9 and 10, when the engaging projections 70 of the cover 30 mesh with the reinforcing ribs 19 of the housing 10, the rotational displacement of the cover 30 with respect to the housing 10 around the axis P of the cap nut 34 is restricted, and the co-rotation of the cover 30 is prevented.

Accordingly, when the inspection plate 80 is bolted to the cover 30, it is possible to prevent the cover 30 from being biased to the opening 16 of the housing 10. As a result, there is no possibility that the seal margin of the seal member 50 cannot be secured due to the generation of the bias of the cover 30 to the opening 16.

In the connector 1 having the above structure, the fitting portion 11 is fitted to a counterpart connector provided in a case such as an inverter or a motor. Accordingly, the tab terminal 41 in the fitting portion 11 is inserted into and electrically connected to the electrical connection portion of the counterpart terminal. When the connector 1 is fitted to the counterpart connector, the packing 24 is brought into close contact with a housing of the counterpart connector. Thus, a fitting portion between the connector 1 and the counterpart connector is sealed.

When the connector 1 is fitted to the counterpart connector, bolts (not illustrated) inserted into the hole portions of the fixing pieces 67 of the upper shield shell 61 and the hole portions of the fixing pieces 64 of the lower shield shell 62 are screwed into screw holes (not illustrated) formed in the case. Thus, the connector 1 is pushed toward the counterpart connector by a fastening force of the bolt. Accordingly, the connector 1 can be easily fitted to the counterpart connector.

Further, since the fixing pieces 67 of the upper shield shell 61 and the fixing pieces 64 of the lower shield shell 62 are fastened by bolts, the shield shell 60 is electrically connected to the case. Accordingly, the connector 1 is covered with the shield shell 60 fixed to the case, and a good electromagnetic shielding effect is obtained.

As described above, according to the connector 1 in the present embodiment, when the inspection plate 80 is bolted to the cover 30, the rotational displacement of the cover 30 with respect to the housing 10 is restricted by the engaging projections 70 of the cover 30 being meshed with the reinforcing ribs 19 of the housing 10. Thus, the co-rotation of the cover 30 due to a fastening torque of the fixing bolt 85 is prevented. As a result, the cover 30 is not biased to the opening 16 of the housing 10, and a sealing margin of the seal member 50 can be ensured to prevent a decrease in sealing pressure, thereby ensuring a good waterproof seal.

In the connector 1 according to the present embodiment, a component fixed to the cover 30 is the inspection plate 80 for holding the blocking plugs 83 that blocks water from entering the inspection holes 37 provided in the cover 30.

Thus, when the confirmation operation is performed as to whether the electric current flows to the tab terminals 41 of the terminal-equipped electric wires 40 by inserting the inspection probes into the inspection holes 37 provided in the cover 30, it is possible to easily detach the inspection plate 80 from the cover 30 by loosening the fixing bolt 85. Further, when the inspection plate 80 is attached to the cover 30, it is possible to reliably seal a gap between the opening 16 of the housing 10 and the cover 30 when the inspection holes 37 are surely water-blocked by the blocking plugs 83.

The present disclosure is not limited to the above embodiments, and can be appropriately modified, improved, and the like. In addition, materials, shapes, sizes, numbers, arrangement positions, or the like of components in the above embodiment are freely selected and are not limited as long as the present disclosure can be implemented.

For example, in the above embodiment, the connector 1 according to the present embodiment has been described by taking a shielded connector as an example, but the present disclosure is not limited thereto, and can be applied to various connectors in which components such as an inspection plate need to be fixed to a cover.

Here, features of a connector according to the embodiment of the present disclosure described above are briefly summarized and listed in the following first to fourth aspects.

According to the first aspect, a connector (1) includes: a housing (10) having a fitting portion (11) configured to be fitted to a counterpart connector; a cover (30) assembled to an opening (16) opposite to the fitting portion (11); an annular seal member (50) configured to seal a gap between an inner peripheral side seal surface (16a) of the opening (16) and an outer peripheral side seal surface (31) of the cover (30); a plurality of reinforcing ribs (19) disposed at predetermined intervals along an inner peripheral surface (10b) of the housing (10) and extending along an assembling direction of the cover (30), the inner peripheral surface (10b) of the housing (10) being located behind the inner peripheral side seal surface (16a) of the opening (16); engaging projections (70) projecting from an inner bottom surface (36) of the cover (30) and configured to restrict displacement of the cover (30) with respect to the housing (10) by being meshed with the reinforcing ribs (19); a component (inspection plate 80) fixed to the cover (30); and a fixing bolt (85) screwed into a nut (cap nut 34) provided on the cover (30) for fixing the component (inspection plate 80).

According to the connector (1) having a configuration of the above first aspect, when a component (inspection plate 80) is bolted to the cover (30), the rotational displacement of the cover (30) with respect to the housing (10) is restricted by the engaging projections 70 of the cover (30) being meshed with the reinforcing ribs (19) of the housing (10). Thus, the co-rotation of the cover (30) due to the fastening torque of the fixing bolt (85) is prevented. As a result, the cover (30) is not biased toward the opening (16) of the housing (10), and a sealing margin of the seal member (50) can be ensured to prevent a decrease in sealing pressure, thereby ensuring a good waterproof seal.

According to the second aspect, in the connector (1) according to the first aspect, the pair of engaging projections (70) are disposed plane-symmetrically with respect to a central plane(S) of the cover (30) including an axis (P) of the nut (cap nut 34).

According to the connector (1) having a configuration of the above second aspect, when the cover (30) rotates about the axis (P) of the nut (cap nut 34), the same rotational moment acts on each of the pair of engaging projections (70). Accordingly, since shapes of the pair of engaging projections (70) on which rotational torque of the cover (30) acts equally can be the same shape in strength, the resin molding of the cover (30) is facilitated.

According to the third aspect, in the connector (1) according to the above first aspect, the engaging projections (70) are a columnar projection having a U-shaped cross-section in which a pair of support pieces (71) having inner surfaces (71a) facing outer surfaces (19b) of the pair of reinforcing ribs (19) in a plate thickness direction and a connection piece (73) connecting the pair of support pieces (71) are integrally formed.

According to the connector (1) having a configuration of the above third aspect, when the cover (30) rotates about the axis (P) of the nut (cap nut 34), the inner surfaces (71a) of the support pieces (71) of the engaging projections (70) can apply rotational torque to the reinforcing ribs (19) while being in surface contact with the outer surfaces (19b). Accordingly, since the stress acting between the engaging projections (70) and the reinforcing ribs (19) can be dispersed, damage to the engaging projections (70) and the reinforcing ribs (19) can be prevented without increasing a size and strength more than necessary.

According to the fourth aspect, in the connector (1) according to any one of the first to third aspects, the component is an inspection plate (80) for holding a blocking plug (83) configured to block water from entering an inspection hole (37) provided in the cover (30).

According to the connector (1) having a configuration of the above fourth aspect, when the confirmation operation is performed as to whether the electric current flows to terminals (tab terminals 41) accommodated in the housing (10) by inserting the inspection probes into the inspection holes (37) provided in the cover (30), it is possible to easily detach the inspection plate (80) from the cover (30) by loosening the fixing bolt (85). Further, when the inspection plate (80) is attached to the cover (30), it is possible to reliably seal a gap between the opening (16) of the housing (10) and the cover (30) when the inspection holes (37) are surely water-blocked by the blocking plugs (83).

What is claimed is:

1. A connector comprising:
a housing having a fitting portion configured to be fitted to a counterpart connector;
a cover assembled to an opening opposite to the fitting portion;
an annular seal member configured to seal a gap between an inner peripheral side seal surface of the opening and an outer peripheral side seal surface of the cover;
a plurality of reinforcing ribs disposed at predetermined intervals along an inner peripheral surface of the housing and extending along an assembling direction of the cover, the inner peripheral surface of the housing being located behind the inner peripheral side seal surface of the opening;
engaging projections projecting from an inner bottom surface of the cover and configured to restrict displacement of the cover with respect to the housing by being meshed with the reinforcing ribs;
a component fixed to the cover; and
a fixing bolt screwed into a nut provided on the cover for fixing the component.

2. The connector according to claim 1, wherein
the pair of engaging projections are disposed plane-symmetrically with respect to a central plane of the cover including an axis of the nut.

3. The connector according to claim 1, wherein
the engaging projections are a columnar projection having a U-shaped cross-section in which a pair of support pieces having inner surfaces facing outer surfaces of the pair of reinforcing ribs in a plate thickness direction and a connection piece connecting the pair of support pieces are integrally formed.

4. The connector according to claim 1, wherein
the component is an inspection plate for holding a blocking plug configured to block water from entering an inspection hole provided in the cover.
